(19) United States
(12) Patent Application Publication
(10) Pub. No.: US 2013/0146431 A1
(43) Pub. Date: Jun. 13, 2013

(54) APPARATUS AND METHOD FOR REMOTELY ACTUATING ELECTRICAL SWITCHGEAR

(71) Applicants: JENNIFER SMITH, Conroe, TX (US); Robert Smith, Conroe, TX (US)

(72) Inventors: JENNIFER SMITH, Conroe, TX (US); Robert Smith, Conroe, TX (US)

(21) Appl. No.: 13/314,424

(22) Filed: Dec. 8, 2011

(51) Int. Cl. H01H 3/20

(52) U.S. Cl. 200/331

(57) ABSTRACT

A system for remotely operating an electrical switch may employ a linear actuator having an actuator rod configured for engagement with a handle of the electrical switch. An actuator switch may be interposed between a power supply and the linear actuator. The actuator switch may be displaced from the linear actuator. An electromagnetic clamp may be attached to the linear actuator and configured to hold the linear actuator in position so that linear motion of the actuator rod produces movement of the handle of the electrical switch when power is applied to the linear actuator from the power supply.

### BACKGROUND OF THE INVENTION

The present invention generally relates to electrical switchgear operation and more particularly to remote actuation of such switchgear.

Various circuit breakers and/or disconnect switches are employed to energize or disconnect electrical power circuits. On some occasions a switch may be closed to energize a high-voltage circuit even though a short circuit fault may be present in the circuit. This may present a dangerous condition and may expose an operator of the switch to physical harm. If a switch is closed to energize such a faulty circuit, the switch may explode because of inordinately high current flow through the switch. A person near the switch may be seriously injured.

As can be seen, there is a need for a switch actuation system in which a person actuating the switch may be located a safe distance away from the switch so that, in the event of an explosion, the person will be unharmed.

### SUMMARY OF THE INVENTION

In one aspect of the present invention, apparatus for remotely operating an electrical switch may comprise: a linear actuator having an actuator rod configured for engagement with a handle of the electrical switch; an actuator switch interposed between a power supply and the linear actuator, the switch being displaced from the linear actuator; and an electromagnetic clamp attached to the linear actuator and being configured to hold the linear actuator in position so that linear motion of the actuator rod produces movement of the handle of the electrical switch when power is applied to the linear actuator from the power supply.

In another aspect of the present invention, a method for remotely operating an electrical switch may comprise the steps of: clamping a linear actuator into a position near the electrical switch so that an actuator rod is engaged with a handle of the electrical switch; and actuating the linear actuator from a location that is remote from the electrical switch so that the actuator rod moves the handle of the electrical switch.

These and other features, aspects and advantages of the present invention will become better understood with reference to the following drawings, description and claims.

### BRIEF DESCRIPTION OF THE DRAWINGS

FIG. 1 is a perspective view of a remote switch actuator in accordance with an embodiment of the invention;

FIGS. 2 and 3 are perspective views of the remote switch actuator of FIG. 1 in an operational mode;

FIG. 4 is a perspective view of remote switch actuator of FIG. 1 positioned on a portable stand; and

FIG. 5 is a perspective view of a portion of the remote switch actuator of FIG. 1 in use with an adapter in accordance with an embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide remote actuation devices for operating switches. More particularly, the actuation devices may be portable and may be moved for use at various switch locations.

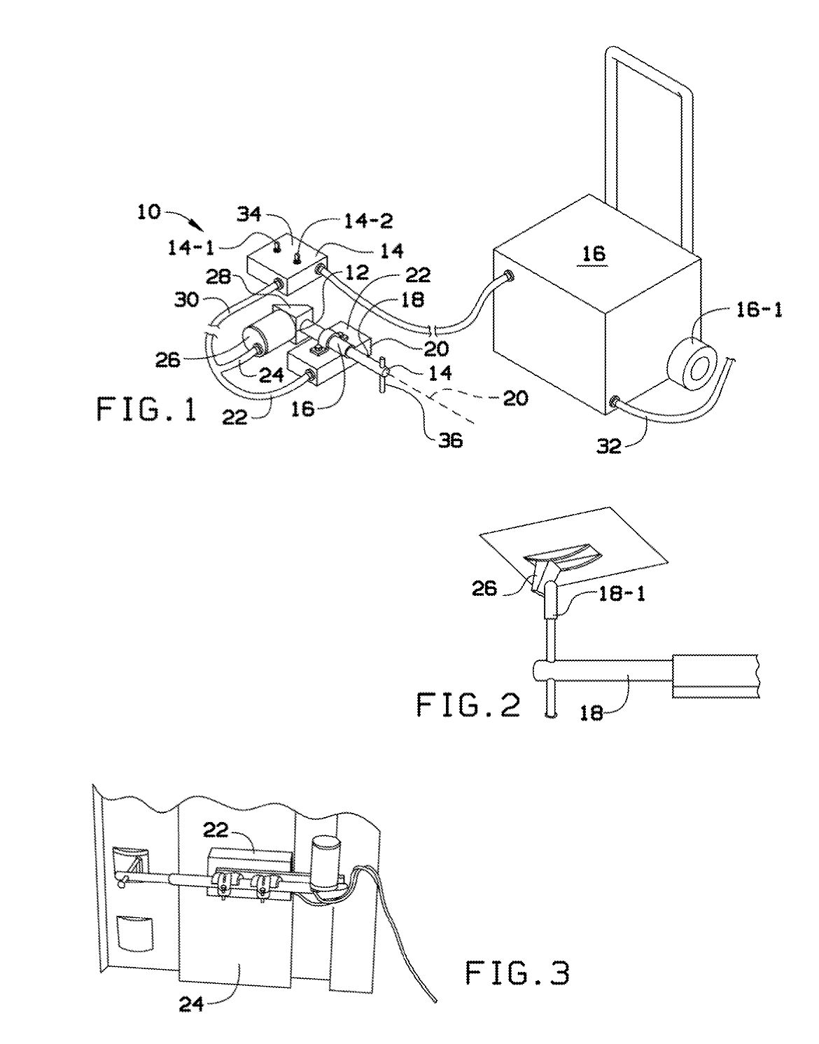

Referring now to FIGS. 1, 2 and 3, it may be seen that an exemplary embodiment of a remote switch actuator 10 may comprise a linear actuator unit 12, control unit 14 and a power supply 16 which may comprise a rechargeable battery. The power supply 16 may be provided with wheels 16-1 so that it may be readily moved to various locations. The linear actuator unit 12 may be a motor-driven unit which may drive an actuator rod 18 linearly, backward or forward, long an axis 20. The actuator unit 12 may be attached to an electromagnetic clamp 22.

In operation, the actuator unit 12 may be placed against a metal housing of a switchgear assembly 24 so that an extension member 18-1 of the actuator rod 18 may be engaged with a switch handle 26. Electrical power from the power supply 16 may be applied to the clamp 22 by operating a clamp switch 14-1 of the control unit 14. The clamp 22 may thus hold the actuator at the selected location. An actuator switch 14-2 of the control unit 14 may then be operated to allow power from the power supply 16 to drive the rod 18 of the linear actuator 12 along the axis 20. Consequently, the switch handle 26 may be moved to a desired position, i.e., either opened or closed.

The control unit 14 may be connected to the linear actuator 12 and the clamp 22 with a long cable (e.g., about 6 feet to about 12 feet in length). Therefore, a person operating the actuator switch 14-2 may be able to stand a substantial distance away from. the switch handle 26 during its operation. In the event of an accidental explosion of the switch, the person may be out of harm's way.

It may be noted that some high-voltage switches may require application of substantial force for movement of their respective handles, sometimes in the order of about 50 pounds to about 100 pounds. Consequently, the clamp 22 may configured so that its clamping force may counteract application of up to about 100 pounds of force by the actuator rod 18 in a direction that is parallel to the axis 20 of the rod 18.

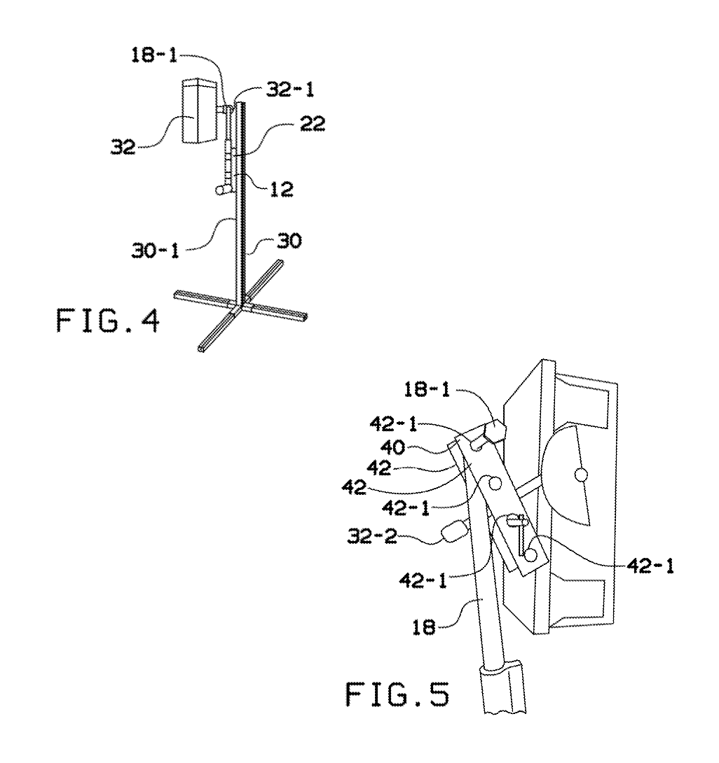

Referring now to FIGS. 4 and 5 it may be seen the remote switch actuator 10 may be employed to operate switches which may not be housed in large metallic switchgear units. In an exemplary application, a portable stand 30 may be positioned near a disconnect switch 32. The stand 30 may be provided with an elongated flat metal mounting plate 30-1. The linear actuator 12 may be positioned so that the extension 18-1 may be engaged with a disconnect handle 32-1. The clamp 22 may be energized to hold the linear actuator 12 against the plate 30-1. The actuator 12 may then be operated remotely, as described above, to change the position of the handle 32-1.

As shown in FIG. 5, some disconnect switches may have handles 33 that are not provided with openings. In such cases, an adapter 40 may be employed to accommodate engagement of the linear actuator 12 with the handle 32-2. The adapter 40 may comprise two flat plates 42 with holes 42-1. A switch-handle engagement rod 44 may be positioned through of the holes 42-1 in each of the plates 42. In other words, the rod 44 may be placed into a first pair of the holes 42-1. The extension 18-1 may be placed through a second pair of the holes 42-1. The actuator 12 may be positioned so that the rod 44 engages with a disconnect handle 32-2. The actuator rod 18 may then be extended so that the disconnect handle 32-2 may be moved.

It should be understood, of course, that the foregoing relates to exemplary embodiments of the invention and that modifications may be made without departing from the spirit and scope of the invention as set forth in the following claims.

What is claimed is:

1. Apparatus for remotely operating an electrical switch comprising:
a linear actuator having an actuator rod configured for engagement with a handle of the electrical switch;
an actuator switch interposed between a power supply and the linear actuator, the switch being displaced from the linear actuator; and
an electromagnetic clamp attached to the linear actuator and being configured to hold the linear actuator in position so that linear motion of the actuator rod produces movement of the handle of the electrical switch when power is applied to the linear actuator from the power supply.

2. The apparatus of claim 1 further comprising the power supply.

3. The apparatus of claim 2 wherein the power supply comprises a rechargeable battery.

4. The apparatus of claim 1 wherein the electromagnetic clamp is configured so that its clamping force can counteract application of up to about 100 pounds of force applied by the actuator rod in a direction that is parallel to an axis of the actuator rod.

5. The apparatus of claim 1 further comprising a portable stand provided with an elongated flat metal mounting plate configured for engagement with the electromagnetic clamp.

6. The apparatus of claim 1 wherein the actuator rod is provided with an extension that projects orthogonally from the rod.

7. The apparatus of claim 1 further comprising an adapter that includes:
two flat plates with at least two holes in each of the plates; and
a switch-handle engagement rod positioned through one of the holes in each of the plates,
wherein at least one of the holes in each of the plates is large enough to accommodate insertion of the orthogonally-oriented extension of the actuator rod.

8. A method for remotely operating an electrical switch comprising the steps of:
clamping a linear actuator into a position near the electrical switch so that an actuator rod is engaged with a handle of the electrical switch; and
actuating the linear actuator from a location that is remote from the electrical switch so that the actuator rod moves the handle of the electrical switch.

9. The method of claim 8 wherein the step of clamping comprises applying electrical power to an electromagnetic clamp that is attached to the linear actuator.

10. The method of claim 8 further comprising the steps of:
positioning a portable stand near the electrical switch;
clamping the linear actuator to the portable stand so that the actuator rod is engaged with a handle of the electrical switch.
